(19) United States
(12) Patent Application Publication
(10) Pub. No.: US 2007/0201550 A1
(43) Pub. Date: Aug. 30, 2007

(54) Method and apparatus for entropy coding in fine granularity scalable video coding

(75) Inventors: Xianglin Wang, Irving, TX (US); Marta Karczewicz, Irving, TX (US); Justin Ridge, Sachse, TX (US); Nejib Ammar, Irving, TX (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/651,910

(22) Filed: Jan. 9, 2007

Related U.S. Application Data
(60) Provisional application No. 60/757,745, filed on Jan. 9, 2006.
(60) Provisional application No. 60/763,164, filed on Jan. 26, 2006.

(51) Int. Cl. H04B 1/66; H04N 11/04; H04N 11/02

(52) U.S. Cl. 375/240.1; 375/240.18; 375/240.21

(57) ABSTRACT

An FGS entropy coding method is suitable for the case when the refinement coefficients at the FGS layer have different prediction from its base layer. When temporal prediction is used in FGS layer coding and the refinement coefficients at the FGS layer have different prediction from its base layer, drift problem may be caused if the FGS layer is partially decoded. Such drift problem may significantly affect coding performance. This new FGS entropy coding method that can solve or greatly alleviate such drift effect and therefore improve coding performance. Three different FGS methods can be used: FGS entropy coding based on spatial frequency location; FGS entropy coding for decoder oriented two-loop structure; and FGS entropy coding with block-confined coding pass.

This patent application is based on and claims priority to U.S. Patent Application Ser. No. 60/757,745, filed Jan. 9, 2006, and U.S. Patent Application Ser. No. 60/763,164, filed Jan. 26, 2006, both assigned to the assignee of the present invention.

### FIELD OF THE INVENTION

The present invention relates generally to video coding and, more particularly, to scalable video coding.

### BACKGROUND OF THE INVENTION

Fine Granularity Scalability (FGS) has recently been added to the MPEG-4 AVC video coding standard in order to increase the flexibility of video coding. With FGS coding, the video is encoded into a base layer (BL) and one or more enhancement layers or FGS layers, as shown in FIG. 1. Similar to conventional scalable video coding, the base layer must be received completely in order to decode and display a basic quality video. In contrast to conventional scalable video coding, which requires the reception of complete enhancement layers to improve upon the basic video quality, with FGS coding the enhancement layer stream can be cut anywhere before transmission or during decoding. In other words, the bitstream of an FGS layer can be arbitrarily truncated for each frame. Thus, FGS allows the quality of a video signal to be incrementally improved by decoding additional information from an FGS layer. If a device receives the video stream over a low rate channel, the decoded video may be of a lower quality. If a device receives the same video stream over a higher-rate channel, the decoded video may be of a higher quality. Truncating the FGS layer permits decoding at essentially arbitrary bitrates above that of the base layer. Truncating a bitstream may affect the coding efficiency.

It is known that the colors in video data can be represented by a mixture of three primary colors of R, G, B. However, various equivalent color spaces are also possible. Many important color spaces comprise a luminance component (Y) and two chrominance components (U, V). Truncation can be related to the color space representation.

In some scenarios, it is desirable to transmit an encoded digital video sequence at some minimum or “base” quality, and in concert transmit an “enhancement” signal that may be combined with the minimum quality signal in order to yield a higher-quality decoded video sequence. Such an arrangement simultaneously allows arbitrary devices supporting some set of minimum capabilities to decode the sequence (at the “base” quality), and those with improved capabilities to decode a higher-quality version of the same sequence, without incurring the increased cost associated with transmitting two independently coded versions of the same sequence.

Should more than two levels of quality be desired, multiple “enhancement” signals can be transmitted, each requiring the “base” quality signal plus all lower-quality “enhancement” signals.

Such “base” and “enhancement” signals are referred to as “layers” in the field of scalable video coding, and the degree to which each enhancement layer improves the reconstructed quality is referred to as the “granularity”. The acronym FGS indicates “fine granularity scalability”, meaning that the incremental quality increases are small.

Techniques for producing FGS enhancement layers are known, and in the context of the current SVC standardization, a block-based FGS scheme was initially documented in ISO/IEC JTC1/SC29/WG11, “Scalable Video Model Version 3.0”, MPEG Document w6716, Palma de Mallorca, October 2004. This coding scheme was later replaced by an improved coding scheme called “cyclic block coding” which can efficiently utilize base layer coded information in the current layer FGS coding to improve coding performance.

According to cyclic block coding scheme, a prediction residual coefficient can be coded as one of the two kinds: significant information or refinement information. From the base layer, if a coefficient has a reconstructed value of zero, it is called non-significant coefficient. Otherwise, it is called significant coefficient. Based on the coefficients coded in base layer, the first FGS layer can be coded. In the first FGS layer coding, a non-significant coefficient from the base layer will be checked again to see whether it becomes significant (i.e. has a reconstructed value of non-zero) at the current FGS layer. If it does, then its magnitude and sign are coded. Otherwise, it is still classified as non-significant. For a significant coefficient from the base layer, it is further refined based on the current FGS layer quantization parameter (QP). Once the first FGS layer is coded, it serves as base layer and the second FGS layer can be coded and so on. Once a coefficient becomes significant at a certain layer, it will be refined just at each following higher FGS layer.

In terms of coding order, the cyclic block coding generally codes the significant information first followed by the refinement information. More specifically, for coding each FGS layer of a slice, there are two passes: significant pass and refinement pass. In the significant pass, only those non-significant coefficients from base layer are checked to see if they become significant in the current layer. If they do, then code their magnitudes and signs. Significant pass ends once all non-significant coefficients from base layer have been checked. In the following refinement pass, all those significant coefficients from base layer are being refined according to current FGS layer QP.

The more detailed procedure of the cyclic block coding can be described with the following pseudo-code.

While values remain to be decoded

For each block
   If significance pass NOT complete for luminance of current slice
      Decode one non-zero luminance coefficient and preceding zeros
   Else
      Decode refinement information for next luminance coefficient
   If significance pass NOT complete for chrominance of current slice
      Decode one non-zero chrominance coefficient from each component and preceding zeros
   Else
      Decode refinement information for next chrominance coefficients
         Thus, for each color component (luminance and chrominance), significant information is coded in front of the refinement information.

The cyclic block coding is found to work well when there is no temporal prediction used in coding FGS layers. An example is shown in FIG. 1. In this structure, the discrete base layer is coded normally in a non-scalable bitstream with motion compensation. The FGS layer is then coded on top of that without motion compensation. Arrows in the figure indicate prediction relationship. Since each FGS layer is fully predicted from its base layer, either the significant pass or the refinement pass of the current FGS layer will only provide additional information that helps improve the picture quality.

In order to further improve coding efficiency in FGS layer coding, various kinds of methods have been recently proposed that utilize temporal prediction in FGS layer coding as well. In these methods, new (or refined) motion vectors may be introduced and separate motion compensation may be performed for FGS layer. With careful design, these methods can effectively improve FGS layer coding efficiency. However, they also create a new issue that is related to the currently used cyclic block coding.

An example is shown in FIG. 2 where temporal prediction is used for FGS layer coding. Assume there is only one FGS layer. In FIG. 4, P₀ and P₁ are the predictions that are formed through motion compensation in the base layer and the FGS layer respectively. Motion vectors at these two layers can either be the same or different. Assume the reconstructed prediction residual at the base layer is D₀, then R₀ can be expressed as R₀=P₀+D₀, where R₀ is the reconstructed frame from the base layer.

As described above, if no temporal prediction is used in FGS layer coding, R₀ would be used as prediction in coding the FGS layer. In this case, cyclic block coding is found to work well. However, when temporal prediction at the FGS layer is used, there will be a problem with cyclic block coding.

In cyclic block coding, the FGS layer is further coded and refined on top of the base layer. In order to utilize temporal prediction at the FGS layer, the prediction for coding FGS layer of frame n would become P₁+D₀ according to FIG. 2. Prediction residual D₁ of the FGS layer is then coded through cyclic block coding. The significant information from coding residual D₁ indicates newly generated significant coefficients at the FGS layer. The refinement information from coding residual D₁ further refines the already significant coefficients from the base layer. However, it should be noted that in this case the refinement information at the FGS layer also compensates for the difference between prediction P₀ and P₁ for those significant coefficients from the base layer. Such issue does not exist when R₀ is used as prediction in coding the FGS layer.

Due to the issue mentioned above, the separate “pass” in cyclic block coding is no longer suitable. If, at the beginning of the FGS layer, all decoded information belongs to significant information, we can expect that the quality of P₁ will get better gradually when more FGS layer bits are decoded. Accordingly, the difference between P₀ and P₁ is also getting larger. However, at this time, refinement information may not have been decoded yet. Without refinement information at the FGS layer, the difference between P₀ and P₁ cannot be compensated appropriately for those significant coefficients from the base layer. This will result in the drift problem which can significant affect coding performance in case of partial FGS layer decoding.

On the other hand, if the refinement pass is coded before the significant pass, there may also be a problem. At the beginning of decoding the FGS layer, decoded information all belongs to refinement information. The compensation for the difference between P₀ and P₁ is available. However, such compensation is for the case when the FGS layer is fully decoded. When only a small portion of the FGS layer is decoded, the temporal prediction formed in this case, P₁, is close to P₀ in terms of picture quality. Therefore, the decoded refinement information may over-compensate the difference between P₁ and P₀. This may also result in the drift problem which affects coding performance in case of partial FGS layer decoding.

The case shown in FIG. 2 is just an example. In general, if the refinement coefficients (i.e. coefficients that are already significant in base layer) at the FGS layer have different prediction from the base layer, the drift problem in case of partial decoding may exist if entropy coding is performed in a separate “pass” manner.

Another example would be the decoder-oriented two-loop structure disclosed in U.S. Patent Application Attorney Docket No. 944-001.177-2, filed even date herewith (hereafter referred to as 944-001.177-2). The structure is shown in FIG. 3. The shown structure provides a simple but efficient solution for coding multiple FGS layers. According to this structure, the prediction of the first FGS layer is formed jointly from the first FGS layer of its reference frame and the reconstructed base layer of the current frame.

For the second FGS layer, an initial prediction, P₂′, is first calculated according to the same FGS coding method, but the discrete base layer is used as the “base layer” and the second FGS layer is used as the “enhancement layer”. P₂′ is then added with the first FGS layer reconstructed residual D₁ (which is indicated with hollow arrow in FIG. 3) and the sum, P₂, is used as actual prediction.
P₂=P₂′+α*D₁
where α is a parameter with 0≦α≦1. Similarly, for the third FGS layer, an initial prediction, P₃′, is first calculated according to the same FGS coding method, but the discrete base layer is used as the “base layer” and the third FGS layer is used as the “enhancement layer”. P₃′ is then added with both the first and the second FGS layer reconstructed residual D₁ and D₂ and the sum, P₃, is used as actual prediction.
P₃=P₃′+α*D₁+β*D₂
where β is also a parameter and 0≦β≦1. β can either be the same as or different from α. Usually both α and β may be set as 1.

With such a coding structure, refinement coefficients at the second FGS layer (except those that are significant in a discrete base layer) may have different prediction from its base layer. The situation is also true for refinement coefficients at the third FGS layer. For that reason, cyclic block coding may not be suitable for coding those FGS layers.

### SUMMARY OF THE INVENTION

The present invention provides an FGS entropy coding method that is suitable for the case when the refinement coefficients at the FGS layer have different prediction from its base layer. When temporal prediction is used in FGS layer coding and the refinement coefficients at the FGS layer have different prediction from its base layer, drift problem may be caused if the FGS layer is partially decoded. Such drift problem may significantly affect coding performance. The present invention provides a new FGS entropy coding method that can solve or greatly alleviate such drift effect and therefore improve coding performance.

Three different FGS methods can be used: FGS entropy coding based on spatial frequency location; FGS entropy coding for decoder oriented two-loop structure; and FGS entropy coding with block-confined coding pass. In the first method, the drift problem is essentially caused by the separate “pass” coding order in the cyclic block coding method. No matter which pass is coded first, the drift problem cannot be avoided in case of partial decoding of FGS layer. Thus, the significant information and the refinement information are no longer coded in separate “pass” in order to solve the above-described problem. Instead, they are coded in an interleaved or mixed order. With the second method, it can be guaranteed that the coefficients that become significant in the base layer have the same prediction at the enhancement layer. Therefore, further refinement of those coefficients at the enhancement layer does not include any compensation of the predictor difference. Thus, refinement information of those coefficients only helps improve picture quality without introducing any drift effect. With the third method, the significant coding pass is confined in a block. For a given block, once all the significant information in the block is coded, the significant pass can be considered as finished for the block and therefore the coding of refinement information in the block can be started.

Thus, the first aspect of the present invention is a method of entropy coding for use in encoding a digital video sequence included in image data, the digital video sequence comprising a number of frames, each frame of said sequence comprising an array of pixels divided into a plurality of blocks. The method comprises:

forming a plurality of blocks of transform coefficients representing the enhancement layer information from the image data;

scanning said plurality of blocks of transform coefficients in multiple coding cycles based on a predetermined order;

selecting in each cycle a subset of transform coefficients from each of said plurality of blocks; and

entropy encoding said selected subset of transform coefficients based on the predetermined order.

The second aspect of the present invention is a method entropy coding for use in decoding a digital video sequence included in image data, the digital video sequence comprising a number of frames, each frame of said sequence comprising an array of pixels divided into a plurality of blocks. The method comprises:

forming a plurality of blocks for storing transform coefficients representing the enhancement layer information from the image data;

scanning said plurality of blocks for storing transform coefficients in multiple coding cycles based on a predetermined order;.

selecting in each cycle a subset of transform coefficients to be decoded for each of said plurality of blocks; and

entropy decoding said selected subset of transform coefficients in each of said plurality of blocks based on the predetermined order.

According to the present invention, the selecting in encoding or decoding is at least based on spatial frequency location of each coefficient in a block, or is performed in a way such that significant coefficients in the block are selected prior to refinement coefficients in the block.

According to the present invention, the transform coefficients include refinement coefficients that are significant in a discrete base layer and remaining coefficients, and the selecting from each block is performed in a way such that refinement coefficients that are significant in discrete base layer are selected first and the remaining coefficients are selected in an order based on their spatial frequency location.

A third aspect of the present invention is an entropy encoder for use in encoding a digital video sequence included in image data, the digital video sequence comprising a number of frames, each frame of said sequence comprising an array of pixels divided into a plurality of blocks. The encoder comprises:

a module for forming a plurality of blocks of transform coefficients representing the enhancement layer information from the image data;

a module for scanning said plurality of blocks of transform coefficients in multiple coding cycles based on a predetermined order;

a module for selecting in each cycle a subset of transform coefficients from each of said plurality of blocks; and

a module for entropy encoding said selected subset of transform coefficients based on the predetermined order, wherein the selecting module is adapted to select the subset of transform coefficients at least based on spatial frequency location of each coefficient in a block, or to select the subset of transform coefficients from each block in a way such that significant coefficients in the block are selected prior to refinement coefficients in the block, or to select the transform coefficients from each block in a way such that refinement coefficients that are significant in discrete base layer are selected first and the remaining coefficients are selected in an order based on their spatial frequency location.

A fourth aspect of the present invention is a decoder for use in decoding a digital video sequence included in image data, the digital video sequence comprising a number of frames, each frame of said sequence comprising an array of pixels divided into a plurality of blocks. The decoder comprises:

a module for forming a plurality of blocks for storing transform coefficients representing the enhancement layer information from the image data;

a module for scanning said plurality of blocks for storing transform coefficients in multiple coding cycles based on a predetermined order;

a module for selecting in each cycle a subset of transform coefficients to be decoded for each of said plurality of blocks; and

a module for entropy decoding said selected subset of transform coefficients in each of said plurality of blocks based on the predetermined order.

The fifth aspect of the present invention is a software application product comprising a computer readable storage medium having software application for use in entropy encoding in scalable video coding, said software application having program codes for carrying out the encoding method as described above.

The sixth aspect of the present invention is a software application product comprising a computer readable storage medium having software application for use in entropy decoding in scalable video coding, said software application having program codes for carrying out the decoding method as described above.

The seventh aspect of the present invention is an electronic device, such as a mobile terminal, comprising an encoder and a decoder for use in encoding and decoding a digital video sequence included in image data, as described above.

### BRIEF DESCRIPTION OF THE DRAWINGS

FIG. 1 shows fine granularity scalability with non temporal prediction in FGS layer.

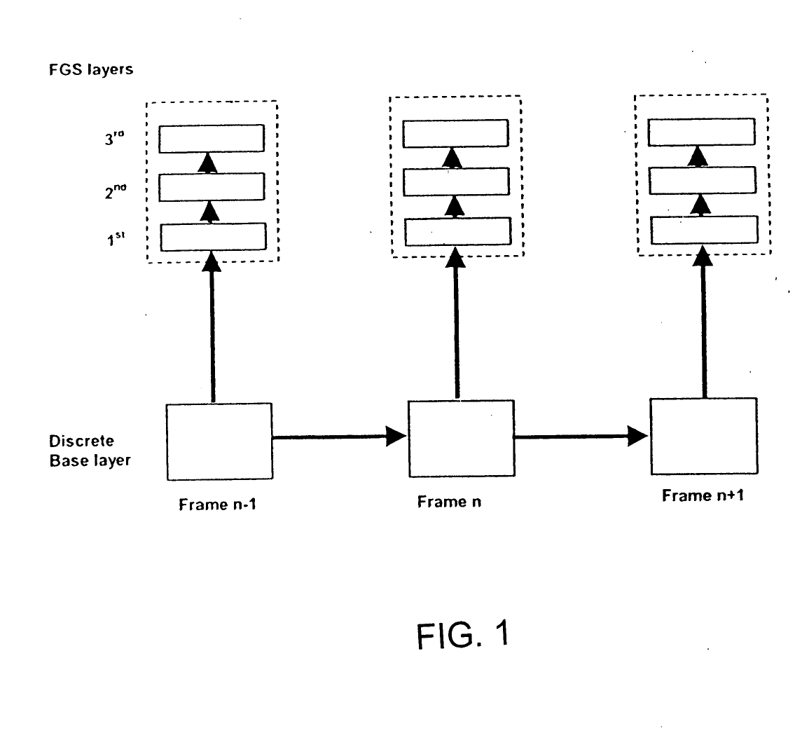

FIG. 2 shows fine granularity scalability with temporal prediction in FGS layer.

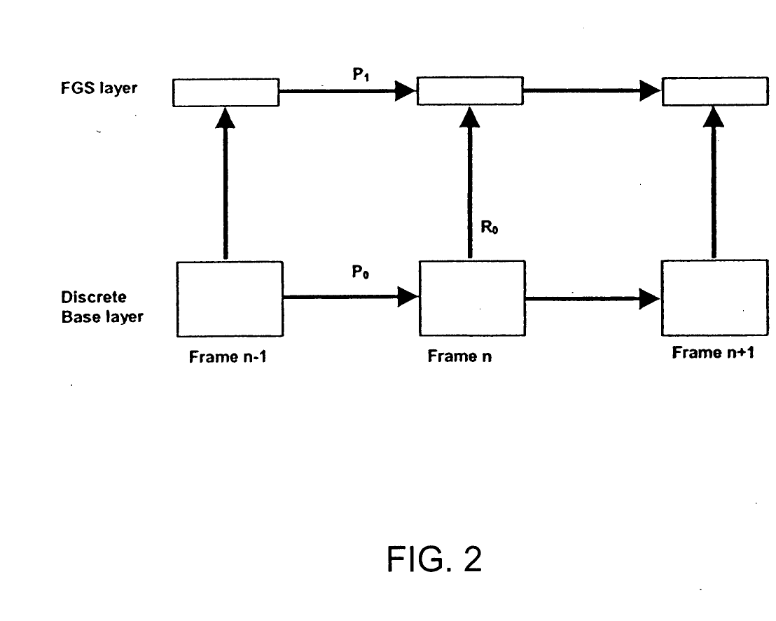

FIG. 3 shows fine granularity scalability with temporal prediction in FGS layers (partial two-loop structure).

FIG. 4 shows a block in FGS layer.

FIG. 5 illustrates an FGS encoder with base-layer-dependent selection of reference blocks.

FIG. 6 illustrates an FGS decoder with base-layer-dependent selection of reference blocks.

FIG. 7 illustrates an electronic device having a least one of the scalable encoder and scalable decoder, according to the present invention.

### DETAILED DESCRIPTION OF THE INVENTION

The present invention provides an FGS entropy coding method that is suitable for the case when the refinement coefficients at the FGS layer have different prediction from its base layer.

Three different FGS entropy coding methods can be used as follows.
1. FGS entropy coding based on spatial frequency location,
2. FGS entropy coding for decoder oriented two-loop structure, and
3. FGS entropy coding with block-confined coding pass.

When temporal prediction is used in FGS layer coding and the refinement coefficients at the FGS layer have different prediction from its base layer, drift problem may be caused if the FGS layer is partially decoded. Such drift problem may significantly affect coding performance. The present invention provides a new FGS entropy coding method that can solve or greatly alleviate such drift effect and therefore improve coding performance.

FGS Entropy Coding Based on Spatial Frequency Location

As explained earlier, the drift problem is essentially caused by the separate “pass” coding order in the cyclic block coding method. No matter which pass is coded first, the drift problem cannot be avoided in case of partial decoding of FGS layer.

According to the present invention, the significant information and the refinement information are no longer coded in separate “pass” in order to solve the above-described problem. Instead, they are coded in an interleaved or mixed order. For instance, they can be coded according their spatial frequency location, which is also the coefficient scanning order as defined in H.264. For the whole frame (or slice in H.264), blocks can still be coded in a cyclic manner. Accordingly, after coding the first coefficient of the first block, the first coefficient of the second block is coded, and the coding moves to the third block and so on. Once the first coefficient of every block is coded in the current slice, start with the first block again and code the second coefficient in the block; code the second coefficient of the second block; and then move to the third block and so on. Such a process is repeated until all the coefficients in every block are coded.

Compared with the current cyclic block coding method, the method, according to the present invention, changes the coding order. There is no change in how a significant/non-significant coefficient is coded or how an already significant coefficient is refined. If there is a non-significant coefficient currently to be coded, coding this coefficient may end up with coding an end-of-block symbol or a series of non-significant coefficients followed by a significant coefficient. In either case, the coded non-significant and significant coefficients along the scanning pass are all marked as “decoded” so that if later a coefficient to be coded is already marked, nothing is coded and the processing is simply moved to the next block.

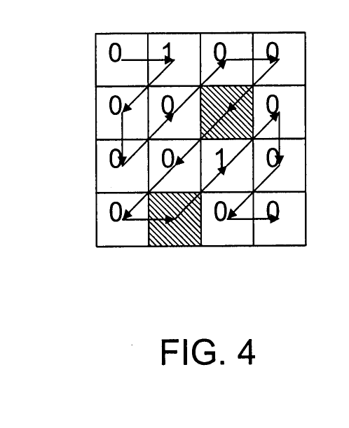

FIG. 4 gives an example of a block in FGS layer. Arrows in this figure indicate scanning order. In this block, two coefficients, at scanning positions 7 and 10 respectively (scanning index starts with 0), marked by shading, became significant in the previous layer (i.e. base layer). They are refinement coefficients at the current FGS layer. Coefficients at position 1 and 11 become significant in the current FGS layer. Here it is assumed that there are 16 cycles for coding a slice and, in each cycle, a coefficient at corresponding spatial frequency location in each block will be coded. Accordingly, in the first cycle, coefficients at position 0 and 1 are coded. In the second cycle, no information needs to be coded from this block because the coefficient at position 1 is already marked as “decoded”. In the third cycle, coefficients from position 2 to 11 are coded. No information is coded for the block in cycle 4, 5, 6 and 7. In cycle 8, coefficient at position 7 is refined. Then no information is coded for the block in cycle 9, 10. In cycle 11, coefficient at position 10 is refined. In cycle 12, no information needs to be coded. In cycle 13, an end-of-block symbol is coded. After that, no information is coded in cycle 14, 15 and 16.

Such a coding order can be expressed with the following pseudo-code.

For each luma scanning index and chroma scanning index

For each block
   If current luma coefficient not decoded
      If current luma coefficient not refinement coefficient Decode a non-zero luma coefficient and preceding zeros
      Else
         Decode refinement information for current luma coefficient
   If current chroma coefficient not decoded
      If current chroma coefficient not refinement coefficient Decode a non-zero chroma coefficient and preceding zeros
      Else
         Decode refinement information for current chroma coefficient
            In the above pseudo-code, luma represents luminance and chroma represents chrominance. The chroma section is actually performed on each chrominance component of Cb and Cr respectively. Meanwhile, it should be noted that luma scanning index and chroma scanning index need not be synchronized. Similar to the current cyclic block coding, the coding of luma can start a few cycles earlier than the coding of chroma.
            FGS Entropy Coding for Decoder Oriented Two-Loop Structure

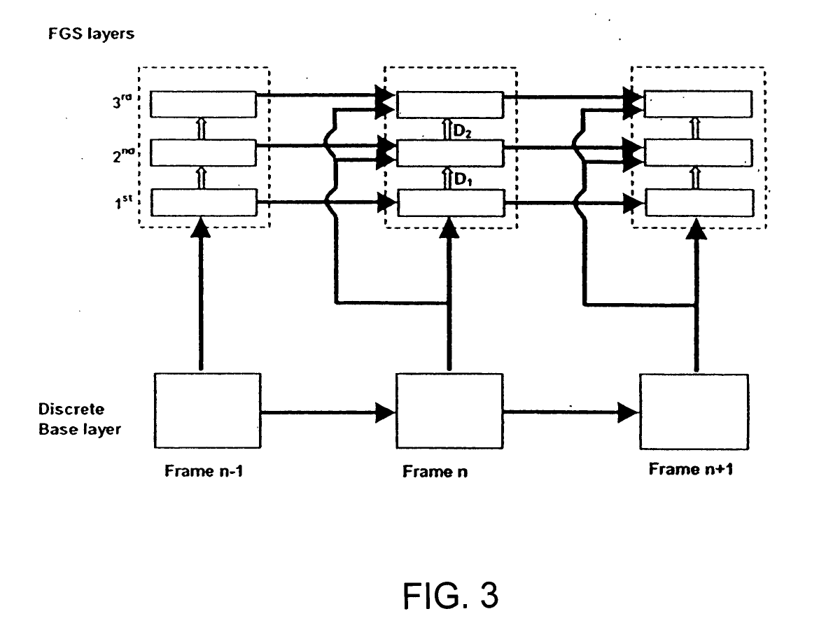

As mentioned earlier, a decoder-oriented two-loop structure is disclosed in 944-001.177-2. The structure as shown in FIG. 3 provides a simple but efficient solution for coding multiple FGS layers. According to this structure, the prediction of the first FGS layer is formed jointly from the first FGS layer of its reference frame and the reconstructed base layer of the current frame.

With this FGS coding method it can be guaranteed that the coefficients that become significant in the base layer have the same prediction at the enhancement layer. Therefore, further refinement of those coefficients at the enhancement layer does not include any compensation of the predictor difference. Thus, refinement information of those coefficients only helps improve picture quality without introducing any drift effect.

For the second FGS layer in FIG. 3, the refinement coefficients at this layer may be classified into two categories. The first category includes the coefficients that become significant at a discrete base layer. The second category includes the coefficients that are not significant at discrete base layer but become significant at the first FGS layer. Since the prediction of the second FGS layer is formed from the discrete base layer and the second FGS layer, the refinement information of the first category coefficients does not cause the drift effect. However, the refinement information of the second category coefficients may cause the drift effect. Such a situation is also true for the third FGS layer. In this case, the first category still includes the coefficients that become significant at the discrete base layer. The second category includes the coefficients that are not significant at discrete base layer but become significant at either the first or second FGS layer.

Based on such analysis, a special FGS entropy coder can be designed for coding the second and third FGS layer when using the coding structure as shown in FIG. 3. Because it only helps improve picture quality and does not introduce any drift effect, the refinement information of the first category coefficients from each block can be coded first, and the remaining coefficients are then coded according to their spatial frequency location. Again, information from each block is coded in a block-cyclic manner.

Such a coding order can be expressed with the following pseudo-code.

For each luma scanning index and chroma scanning index

For each block
   If current luma coefficient is first category coefficient Decode refinement information for current luma coefficient
   If current chroma coefficient is first category coefficient Decode refinement information for current chroma coefficient
      For each luma scanning index and chroma scanning index
For each block
   If current luma coefficient not decoded
      If current luma coefficient not refinement coefficient Decode a non-zero luma coefficient and preceding zeros
      Else
         Decode refinement information for current luma coefficient
   If current chroma coefficient not decoded
      If current chroma coefficient not refinement coefficient Decode a non-zero chroma coefficient and preceding zeros
      Else
         Decode refinement information for current chroma coefficient
            Again in the above pseudo-code, the chroma section is actually performed on each chrominance component of Cb and Cr respectively.
            FGS Entropy Coding with Block-Confined Coding Pass

FGS entropy coding can also be designed according to the following pseudo-code.

While values remain to be decoded

For each block
   If significance pass NOT complete for luminance of the block
      Decode one non-zero luminance coefficient and preceding zeros
   Else
      Decode refinement information for next luminance coefficient
   If significance pass NOT complete for chrominance of the block
      Decode one non-zero chrominance coefficient from each component and preceding zeros
   Else
      Decode refinement information for next chrominance coefficients

From the pseudo-code, we can see that, in this method, the significant coding pass is confined in a block. For a given block, once all the significant information in the block is coded, the significant pass can be considered as finished for the block and therefore the coding of refinement information in the block can be started. According to this method, it is possible for the refinement information of one block to be coded earlier than the significant information of another block for the same color component. In contrast, in the cyclic block coding method, the refinement information for a certain color component is not coded until the significant information of all blocks in a slice is coded. Thus, to some extent, such FGS entropy coding with block-confined coding pass can also offer interleaved coding of significant information and refinement information of an FGS frame (or slice).

Overview of the FGS Coder

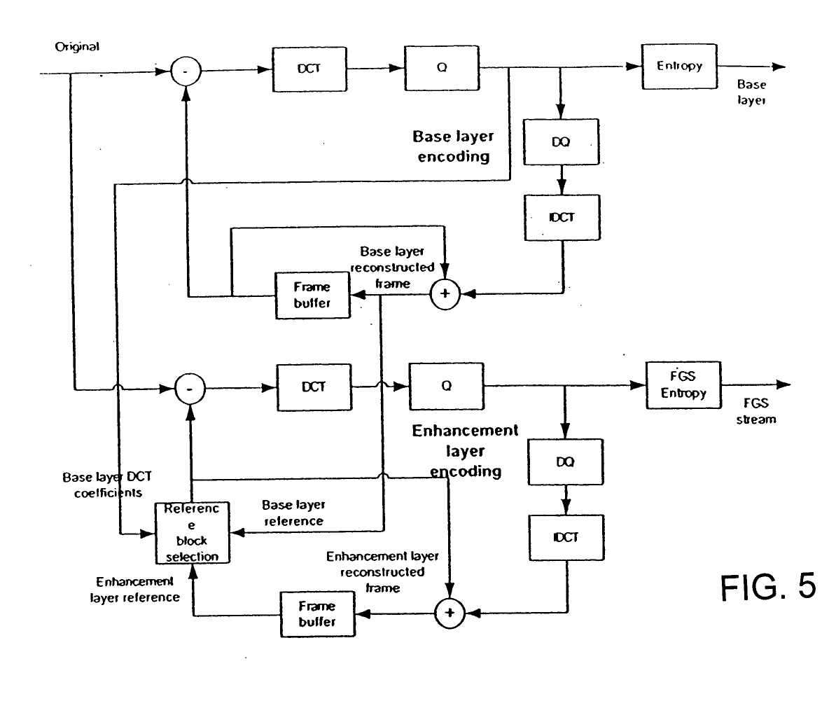

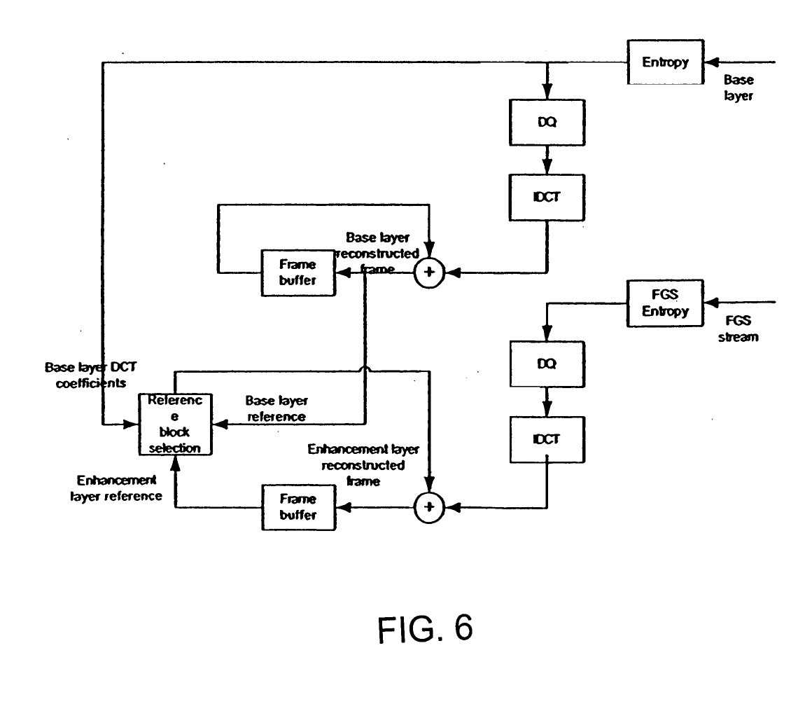

FIGS. 5 and 6 are block diagrams of the FGS encoder and decoder of the present invention wherein the formation of reference blocks is dependent upon the base layer. In these block diagrams, only one FGS layer is shown. However, it should be appreciated that the extension of one FGS layer to a structure having multiple FGS layers is straightforward.

As can be seen from the block diagrams, the FGS coder is a 2-loop video coder with an additional “reference block formation module”.

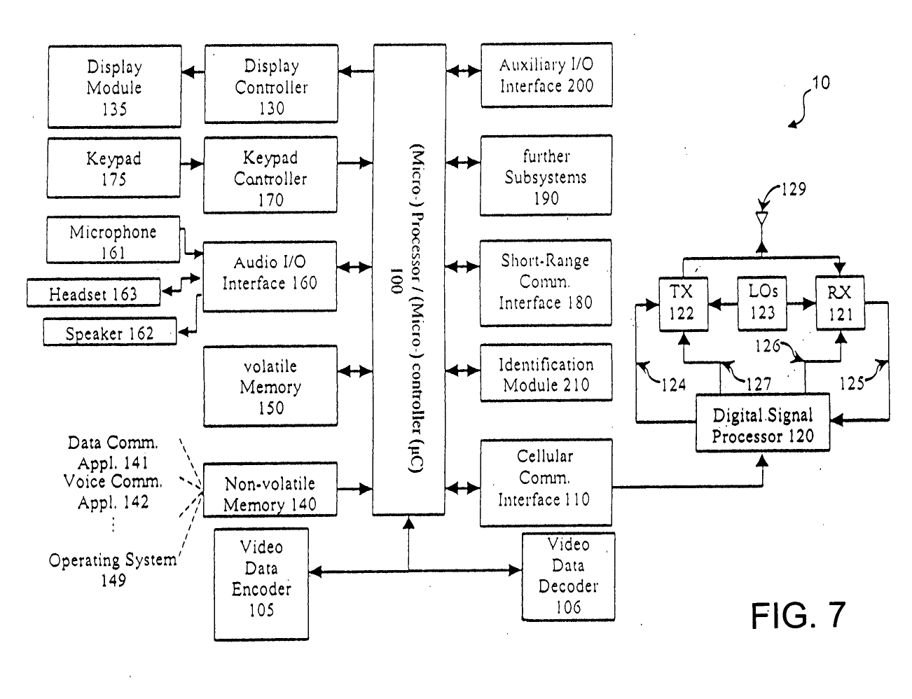

FIG. 7 depicts a typical mobile device according to an embodiment of the present invention. The mobile device 10 shown in FIG. 7 is capable of cellular data and voice communications. It should be noted that the present invention is not limited to this specific embodiment, which represents one of a multiplicity of different embodiments. The mobile device 10 includes a (main) microprocessor or microcontroller 100 as well as components associated with the microprocessor controlling the operation of the mobile device. These components include a display controller 130 connecting to a display module 135, a non-volatile memory 140, a volatile memory 150 such as a random access memory (RAM), an audio input/output (I/O) interface 160 connecting to a microphone 161, a speaker 162 and/or a headset 163, a keypad controller 170 connected to a keypad 175 or keyboard, any auxiliary input/output (I/O) interface 200, and a short-range communications interface 180. Such a device also typically includes other device subsystems shown generally at 190.

The mobile device 10 may communicate over a voice network and/or may likewise communicate over a data network, such as any public land mobile network (PLMN) in form of e.g. digital cellular networks, especially GSM (global system for mobile communication) or UMTS (universal mobile telecommunications system). Typically the voice and/or data communication is operated via an air interface, i.e. a cellular communication interface subsystem in cooperation with further components (see above) to a base station (BS) or node B (not shown) being part of a radio access network (RAN) of the infrastructure of the cellular network. The cellular communication interface subsystem as depicted illustratively in FIG. 7 comprises the cellular interface 110, a digital signal processor (DSP) 120, a receiver (RX) 121, a transmitter (TX) 122, and one or more local oscillators (LOs) 123 and enables the communication with one or more public land mobile networks (PLMNs). The digital signal processor (DSP) 120 sends communication signals 124 to the transmitter (TX) 122 and receives communication signals 125 from the receiver (RX) 121. In addition to processing communication signals, the digital signal processor 120 also provides for receiver control signals 126 and transmitter control signal 127. For example, besides the modulation and demodulation of the signals to be transmitted and signals received, respectively, the gain levels applied to communication signals in the receiver (RX) 121 and transmitter (TX) 122 may be adaptively controlled through automatic gain control algorithms implemented in the digital signal processor (DSP) 120. Other transceiver control algorithms could also be implemented in the digital signal processor (DSP) 120 in order to provide more sophisticated control of the transceiver 122. In case the mobile device 10 communications through the PLMN occur at a single frequency or a closely-spaced set of frequencies, then a single local oscillator (LO) 123 may be used in conjunction with the transmitter (TX) 122 and receiver (RX) 121. Alternatively, if different frequencies are utilized for voice/data communications or transmission versus reception, then a plurality of local oscillators can be used to generate a plurality of corresponding frequencies. Although the mobile device 10 depicted in FIG. 7 is used with the antenna 129 as or with a diversity antenna system (not shown), the mobile device 10 could be used with a single antenna structure for signal reception as well as transmission. Information, which includes both voice and data information, is communicated to and from the cellular interface 110 via a data link between the digital signal processor (DSP) 120. The detailed design of the cellular interface 110, such as frequency band, component selection, power level, etc., will be dependent upon the wireless network in which the mobile device 100 is intended to operate.

After any required network registration or activation procedures, which may involve the subscriber identification module (SIM) 210 required for registration in cellular networks, have been completed, the mobile device 10 may then send and receive communication signals, including both voice and data signals, over the wireless network. Signals received by the antenna 129 from the wireless network are routed to the receiver 121, which provides for such operations as signal amplification, frequency down conversion, filtering, channel selection, and analog to digital conversion. Analog to digital conversion of a received signal allows more complex communication f functions, such as digital demodulation and decoding, to be performed using the digital signal processor (DSP) 120. In a similar manner, signals to be transmitted to the network are processed, including modulation and encoding, for example, by the digital signal processor (DSP) 120 and are then provided to the transmitter 122 for digital to analog conversion, frequency up conversion, filtering, amplification, and transmission to the wireless network via the antenna 129.

The microprocessor/microcontroller (μC) 110, which may also be designated as a device platform microprocessor, manages the functions of the mobile device 10. Operating system software 149 used by the processor 110 is preferably stored in a persistent store such as the non-volatile memory 140, which may be implemented, for example, as a Flash memory, battery backed-up RAM, any other non-volatile storage technology, or any combination thereof. In addition to the operating system 149, which controls low-level functions as well as (graphical) basic user interface functions of the mobile device 10, the non-volatile memory 140 includes a plurality of high-level software application programs or modules, such as a voice communication software application 142, a data communication software application 141, an organizer module (not shown), or any other type of software module (not shown). These modules are executed by the processor 100 and provide a high-level interface between a user of the mobile device 10 and the mobile device 10. This interface typically includes a graphical component provided through the display 135 controlled by a display controller 130 and input/output components provided through a keypad 175 connected via a keypad controller 170 to the processor 100, an auxiliary input/output (I/O) interface 200, and/or a short-range (SR) communication interface 180. The auxiliary I/O interface 200 comprises especially USB (universal serial bus) interface, serial interface, MMC (multimedia card) interface and related interface technologies/standards, and any other standardized or proprietary data communication bus technology, whereas the short-range communication interface radio frequency (RF) low-power interface includes especially WLAN (wireless local area network) and Bluetooth communication technology or an IRDA (infrared data access) interface. The RF low-power interface technology referred to herein should especially be understood to include any IEEE 801.xx standard technology, which description is obtainable from the Institute of Electrical and Electronics Engineers. Moreover, the auxiliary I/O interface 200 as well as the short-range communication interface 180 may each represent one or more interfaces supporting one or more input/output interface technologies and communication interface technologies, respectively. The operating system, specific device software applications or modules, or parts thereof, may be temporarily loaded into a volatile store 150 such as a random access memory (typically implemented on the basis of DRAM (direct random access memory) technology for faster operation). Moreover, received communication signals may also be temporarily stored to volatile memory 150, before permanently writing them to a file system located in the non-volatile memory 140 or any mass storage preferably detachably connected via the auxiliary I/O interface for storing data. It should be understood that the components described above represent typical components of a traditional mobile device 10 embodied herein in the form of a cellular phone. The present invention is not limited to these specific components and their implementation depicted merely for illustration and for the sake of completeness.

An exemplary software application module of the mobile device 10 is a personal information manager application providing PDA functionality including typically a contact manager, calendar, a task manager, and the like. Such a personal information manager is executed by the processor 100, may have access to the components of the mobile device 10, and may interact with other software application modules. For instance, interaction with the voice communication software application allows for managing phone calls, voice mails, etc., and interaction with the data communication software application enables for managing SMS (soft message service), MMS (multimedia service), e-mail communications and other data transmissions. The non-volatile memory 140 preferably provides a file system to facilitate permanent storage of data items on the device including particularly calendar entries, contacts etc. The ability for data communication with networks, e.g. via the cellular interface, the short-range communication interface, or the auxiliary I/O interface enables upload, download, and synchronization via such networks.

The application modules 141 to 149 represent device functions or software applications that are configured to be executed by the processor 100. In most known mobile devices, a single processor manages and controls the overall operation of the mobile device as well as all device functions and software applications. Such a concept is applicable for today's mobile devices. The implementation of enhanced multimedia functionalities includes, for example, reproducing of video streaming applications, manipulating of digital images, and video sequences captured by integrated or detachably connected digital camera functionality. The implementation may also include gaming applications with sophisticated graphics driving the requirement of computational power. One way to deal with the requirement for computational power, which has been pursued in the past, solves the problem for increasing computational power by implementing powerful and universal processor cores. Another approach for providing computational power is to implement two or more independent processor cores, which is a well known methodology in the art. The advantages of several independent processor cores can be immediately appreciated by those skilled in the art. Whereas a universal processor is designed for carrying out a multiplicity of different tasks without specialization to a pre-selection of distinct tasks, a multi-processor arrangement may include one or more universal processors and one or more specialized processors adapted for processing a predefined set of tasks. Nevertheless, the implementation of several processors within one device, especially a mobile device such as mobile device 10, requires traditionally a complete and sophisticated re-design of the components.

In the following, the present invention will provide a concept which allows simple integration of additional processor cores into an existing processing device implementation enabling the omission of expensive complete and sophisticated redesign. The inventive concept will be described with reference to system-on-a-chip (SoC) design. System-on-a-chip (SoC) is a concept of integrating at least numerous (or all) components of a processing device into a single high-integrated chip. Such a system-on-a-chip can contain digital, analog, mixed-signal, and often radio-frequency functions—all on one chip. A typical processing device comprises a number of integrated circuits that perform different tasks. These integrated circuits may include especially microprocessor, memory, universal asynchronous receiver-transmitters (UARTs), serial/parallel ports, direct memory access (DMA) controllers, and the like. A universal asynchronous receiver-transmitter (UART) translates between parallel bits of data and serial bits. The recent improvements in semiconductor technology caused that very-large-scale integration (VLSI) integrated circuits enable a significant growth in complexity, making it possible to integrate numerous components of a system in a single chip. With reference to FIG. 7, one or more components thereof, e.g. the controllers 130 and 160, the memory components 150 and 140, and one or more of the interfaces 200, 180 and 110, can be integrated together with the processor 100 in a signal chip which forms finally a system-on-a-chip (Soc).

Additionally, said device 10 is equipped with a module for scalable encoding 105 and scalable decoding 106 of video data according to the inventive operation of the present invention. By means of the CPU 100 said modules 105, 106 may individually be used. However, said device 10 is adapted to perform video data encoding or decoding respectively. Said video data may be received by means of the communication modules of the device or it also may be stored within any imaginable storage means within the device 10.

In sum, the present invention provides an FGS entropy coding method that is suitable for the case when the refinement coefficients at the FGS layer have different prediction from its base layer. When temporal prediction is used in FGS layer coding and the refinement coefficients at the FGS layer have different prediction from its base layer, drift problem may be caused if the FGS layer is partially decoded. Such drift problem may significantly affect coding performance. The present invention provides a new FGS entropy coding method that can solve or greatly alleviate such drift effect and therefore improve coding performance.

Three different FGS methods can be used: FGS entropy coding based on spatial frequency location; FGS entropy coding for decoder oriented two-loop structure; and FGS entropy coding with block-confined coding pass. In the first method, the drift problem is essentially caused by the separate “pass” coding order in the cyclic block coding method. No matter which pass is coded first, the drift problem cannot be avoided in case of partial decoding of FGS layer. Thus, the significant information and the refinement information are no longer coded in separate “pass” in order to solve the above-described problem. Instead, they are coded in an interleaved or mixed order. With the second method, it can be guaranteed that the coefficients that become significant in the base layer have the same prediction at the enhancement layer. Therefore, further refinement of those coefficients at the enhancement layer does not include any compensation of the predictor difference. Thus, refinement information of those coefficients only helps improve picture quality without introducing any drift effect. With the third method, the significant coding pass is confined in a block. For a given block, once all the significant information in the block is coded, the significant pass can be considered as finished for the block and therefore the coding of refinement information in the block can be started.

Accordingly, the present invention provides a method of entropy coding for use in encoding a digital video sequence included in image data, the digital video sequence comprising a number of frames, each frame of said sequence comprising an array of pixels divided into a plurality of blocks. The method comprises:

forming a plurality of blocks of transform coefficients representing the enhancement layer information from the image data;

scanning said plurality of blocks of transform coefficients in multiple coding cycles based on a predetermined order;

selecting in each cycle a subset of transform coefficients from each of said plurality of blocks; and

entropy encoding said selected subset of transform coefficients based on the predetermined order.

The present invention also provides a method entropy coding for use in decoding a digital video sequence included in image data, the digital video sequence comprising a number of frames, each frame of said sequence comprising an array of pixels divided into a plurality of blocks. The method comprises:

forming a plurality of blocks for storing transform coefficients representing the enhancement layer information from the image data;

scanning said plurality of blocks for storing transform coefficients in multiple coding cycles based on a predetermined order;

selecting in each cycle a subset of transform coefficients to be decoded for each of said plurality of blocks; and

entropy decoding said selected subset of transform coefficients in each of said plurality of blocks based on the predetermined order.

According to the present invention, the selecting in encoding or decoding is at least based on spatial frequency location of each coefficient in a block, or is performed in a way such that significant coefficients in the block are selected prior to refinement coefficients in the block. When the transform coefficients include refinement coefficients that are significant in a discrete base layer and remaining coefficients, and the selecting from each block is performed in a way such that refinement coefficients that are significant in discrete base layer are selected first and the remaining coefficients are selected in an order based on their spatial frequency location.

The present invention provides an entropy encoder for use in encoding a digital video sequence included in image data, the digital video sequence comprising a number of frames, each frame of said sequence comprising an array of pixels divided into a plurality of blocks. The encoder comprises:

a module for forming a plurality of blocks of transform coefficients representing the enhancement layer information from the image data;

a module for scanning said plurality of blocks of transform coefficients in multiple coding cycles based on a predetermined order;

a module for selecting in each cycle a subset of transform coefficients from each of said plurality of blocks; and

a module for entropy encoding said selected subset of transform coefficients based on the predetermined order, wherein the selecting module is adapted to select the subset of transform coefficients at least based on spatial frequency location of each coefficient in a block, or to select the subset of transform coefficients from each block in a way such that significant coefficients in the block are selected prior to refinement coefficients in the block, or to select the transform coefficients from each block in a way such that refinement coefficients that are significant in discrete base layer are selected first and the remaining coefficients are selected in an order based on their spatial frequency location.

The present invention further provides a decoder for use in decoding a digital video sequence included in image data, the digital video sequence comprising a number of frames, each frame of said sequence comprising an array of pixels divided into a plurality of blocks. The decoder comprises:

a module for forming a plurality of blocks for storing transform coefficients representing the enhancement layer information from the image data;

a module for scanning said plurality of blocks for storing transform coefficients in multiple coding cycles based on a predetermined order;

a module for selecting in each cycle a subset of transform coefficients to be decoded for each of said plurality of blocks; and

a module for entropy decoding said selected subset of transform coefficients in each of said plurality of blocks based on the predetermined order.

The above-described encoding and decoding method can be implemented in a a software application product comprising a computer readable storage medium having software application for use in entropy encoding in scalable video coding, said software application having program codes for carrying out the encoding or decoding method as described above.

The above-described encoder and decoder can be implemented in an electronic device, such as a mobile terminal.

Thus, although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. A method of entropy coding for use in encoding a digital video sequence included in image data, the digital video sequence comprising a number of frames, each frame of said sequence comprising an array of pixels divided into a plurality of blocks, said method comprising:
forming a plurality of blocks of transform coefficients representing the enhancement layer information from the image data;
scanning said plurality of blocks of transform coefficients in multiple coding cycles based on a predetermined order;
selecting in each cycle a subset of transform coefficients from each of said plurality of blocks; and
entropy encoding said selected subset of transform coefficients based on the predetermined order.

2. The method of claim 1, wherein said selecting is at least based on spatial frequency location of each coefficient in a block.

3. The method of claim 1, wherein said selecting from each block is performed in a way such that significant coefficients in the block are selected prior to refinement coefficients in the block.

4. The method of claim 1, wherein the transform coefficients include refinement coefficients that are significant in a discrete base layer and remaining coefficients, and wherein said selecting from each block is performed in a way such that refinement coefficients that are significant in discrete base layer are selected first and the remaining coefficients are selected in an order based on their spatial frequency location.

5. A method of entropy coding for use in decoding a digital video sequence included in image data, the digital video sequence comprising a number of frames, each frame of said sequence comprising an array of pixels divided into a plurality of blocks, said method comprising:
forming a plurality of blocks for storing transform coefficients representing the enhancement layer information from the image data;
scanning said plurality of blocks for storing transform coefficients in multiple coding cycles based on a predetermined order;
selecting in each cycle a subset of transform coefficients to be decoded for each of said plurality of blocks; and
entropy decoding said selected subset of transform coefficients in each of said plurality of blocks based on the predetermined order.

6. The method of claim 5, wherein said selecting is at least based on spatial frequency location of each coefficient in a block.

7. The method of claim 5, wherein said selecting from each block is performed in a way such that significant coefficients in the block are selected prior to refinement coefficients in the block.

8. The method of claim 5, wherein the transform coefficients include refinement coefficients that are significant in a discrete base layer and remaining coefficients, and wherein said selecting from each block is performed in a way such that refinement coefficients that are significant in discrete base layer are selected first and the remaining coefficients are selected in an order based on their spatial frequency location.

9. An entropy encoder for use in encoding a digital video sequence included in image data, the digital video sequence comprising a number of frames, each frame of said sequence comprising an array of pixels divided into a plurality of blocks, said encoder comprising:
a module for forming a plurality of blocks of transform coefficients representing the enhancement layer information from the image data;
a module for scanning said plurality of blocks of transform coefficients in multiple coding cycles based on a predetermined order;
a module for selecting in each cycle a subset of transform coefficients from each of said plurality of blocks; and
a module for entropy encoding said selected subset of transform coefficients based on the predetermined order.

10. The encoder of claim 9, wherein said selecting module is adapted to select the subset of transform coefficients at least based on spatial frequency location of each coefficient in a block.

11. The encoder of claim 9, wherein said selecting module is adapted to select the subset of transform coefficients from each block in a way such that significant coefficients in the block are selected prior to refinement coefficients in the block.

12. The encoder of claim 9, wherein the transform coefficients include refinement coefficients that are significant in a discrete base layer and remaining coefficients, and wherein said selecting module is adapted to select the transform coefficients from each block in a way such that refinement coefficients that are significant in discrete base layer are selected first and the remaining coefficients are selected in an order based on their spatial frequency location.

13. A decoder for use in decoding a digital video sequence included in image data, the digital video sequence comprising a number of frames, each frame of said sequence comprising an array of pixels divided into a plurality of blocks, said decoder comprising:
a module for forming a plurality of blocks for storing transform coefficients representing the enhancement layer information from the image data;
a module for scanning said plurality of blocks for storing transform coefficients in multiple coding cycles based on a predetermined order;
a module for selecting in each cycle a subset of transform coefficients to be decoded for each of said plurality of blocks; and
a module for entropy decoding said selected subset of transform coefficients in each of said plurality of blocks based on the predetermined order.

14. The decoder of claim 13, wherein said selecting module is adapted to select the transform coefficients at least based on spatial frequency location of each coefficient in a block.

15. The decoder of claim 13, wherein said selecting module is adapted to select the transform coefficients from each block in a way such that significant coefficients in the block are selected prior to refinement coefficients in the block.

16. The decoder of claim 13, wherein the transform coefficients include refinement coefficients that are significant in a discrete base layer and remaining coefficients, and wherein said selecting module is adapted to select the transform coefficients from each block is performed in a way such that refinement coefficients that are significant in discrete base layer are selected first and the remaining coefficients are selected in an order based on their spatial frequency location.

17. A software application product comprising a computer readable storage medium having software application for use in entropy encoding in scalable video coding, said software application having program codes for carrying out the method of claim 1.

18. A software application product comprising a computer readable storage medium having software application for use in entropy decoding in scalable video coding, said software application having program codes for carrying out the method of claim 5.

19. An electronic device comprising:
an encoder and a decoder for use in encoding and decoding a digital video sequence included in image data, the digital video sequence comprising a number of frames, each frame of said sequence comprising an array of pixels divided into a plurality of blocks, wherein the encoder comprises:
a module for forming a plurality of blocks of transform coefficients representing the enhancement layer information from the image data;
a module for scanning said plurality of blocks of transform coefficients in multiple coding cycles based on a predetermined order;
a module for selecting in each cycle a subset of transform coefficients from each of said plurality of blocks; and
a module for entropy encoding said selected subset of transform coefficients based on the predetermined order; and
the decoder comprises:
a module for forming a plurality of blocks for storing transform coefficients representing the enhancement layer information from the image data;
a module for scanning said plurality of blocks for storing transform coefficients in multiple coding cycles based on a predetermined order;
a module for selecting in each cycle a subset of transform coefficients to be decoded for each of said plurality of blocks; and
a module for entropy decoding said selected subset of transform coefficients in each of said plurality of blocks based on the predetermined order.

20. The electronic device of claim 19, comprising a mobile terminal.
